(19) United States
(12) Patent Application Publication
(10) Pub. No.: US 2008/0104099 A1
(43) Pub. Date: May 1, 2008

(54) USE OF INFORMATION CORRELATION FOR RELEVANT INFORMATION

(75) Inventors: Thomas J. Walczak, Woodstock, IL (US); Carlton J. Sparrell, Marblehead, MA (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/555,081

(22) Filed: Oct. 31, 2006

(51) Int. Cl. G06F 17/30

(52) U.S. Cl. 707/102

(57) ABSTRACT

A method, information processing system, and portable electronic device for associating metadata with a media file are disclosed. The method includes storing at least one media file (216) associated with identification information. A data set is retrieved from at least one data source. The data set is retrieved at least in part based on the identification information. Metadata (220) is automatically generated without user intervention from the data set based at least in part on the identification information. The metadata (220) is associated with the at least one media file (216).

### FIELD OF THE INVENTION

The present invention generally relates to the field image processing, and more particularly relates to image identification based on correlated information.

### BACKGROUND OF THE INVENTION

Digital imaging device such as digital cameras have increased in popularity over the recent years. The increase in popularity of these devices can be attributed in part to an improvement in the technology. Digital imaging devices have become faster, smaller (more portable), and the picture quality has improved. Many of the current digital imaging devices can be connected to a computer for transferring the digital images. Alternatively, most digital imaging devices use removable memory for storing the images, which can then be transferred to a computing system via a corresponding adapter.

When a digital image is captured, the image is usually stored within the device with a default file name. When the image is transferred to a computer for example, the file can transfer with its current file name or the computing system may create its own file. Along with the file name, metadata information can be attached to the image. However, current methods of attaching metadata are for a user to manually enter the metadata information.

For example, through an interface on the digital imaging device or the computing system, a user can enter the location of the picture, the date and time the picture was taken, an event associated with the picture, and the like. The metadata information, among other things, allows a user to easily search for specific images and to recall the circumstances of the image. However, manual entry of metadata information can be very tedious and time consuming, especially for a large number of image files.

Therefore, a need exists to overcome the problems with the prior art as discussed above.

### SUMMARY OF THE INVENTION

Briefly, in accordance with the present invention, disclosed are a system, method, and wireless device for associating metadata with a media file. The method comprises storing at least one media file associated with identification information. A data set is retrieved from at least one data source. The data set is retrieved at least in part based on the identification information. Metadata is automatically generated without user intervention from the data set based at least in part on the identification information. The metadata is associated with the at least one media file.

In another embodiment, an information processing system for associating metadata with a media file is disclosed. The information processing system includes

a memory comprising at least identification information for at least one media file. A processor is communicatively coupled with the memory. The information processing system also includes a metadata querier communicatively coupled with the memory and the processor. The metadata querier retrieves a data set from at least one data source. The data set is retrieved at least in part based on the identification information. A metadata associator communicatively coupled to the metadata querier. The metadata associator automatically, and without user intervention, generates metadata from the data set based at least in part on the identification information.

In yet another embodiment, a portable electronic device is disclosed. The portable electronic device includes a memory comprising at least one media file associated with identification information. A processor is communicatively coupled with the memory. A metadata querier is communicatively coupled with the memory and the processor. The metadata querier retrieves a data set from at least one data source. The data set is retrieved at least in part based on the identification information. A metadata associator is communicatively coupled to the metadata querier. The metadata associator automatically, and without user intervention, generates metadata from the data set based at least in part on the identification information. The metadata associator associates the metadata with the at least one media file.

An advantage of an embodiment of the present invention is that metadata information can be automatically associated with a picture. A user is not required to manually enter metadata information. For example, once a digital imaging device such as a camera captures a picture, the present invention attaches metadata to the picture. The metadata can be retrieved from various components such as a calendar application, GPS coordinates, external databases, and the like. Therefore, more detailed and useful metadata can be attached to the image files for efficient retrieval and recall.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a wireless communication system according to an embodiment of the present invention;

FIG. 2 is a block diagram illustrating a detailed view of a wireless communication device according to an embodiment of the present invention;

FIG. 3 illustrates an example of metadata information associated with an image file according to an embodiment of the present invention;

FIG. 4 is a block diagram illustrating a detailed view of an information processing system according to an embodiment of the present invention;

FIG. 5 is an operational flow diagram illustrating a process of associating a media file with metadata information; and

FIG. 6 is an operational flow diagram illustrating another process of associating a media file with metadata information.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Wireless System

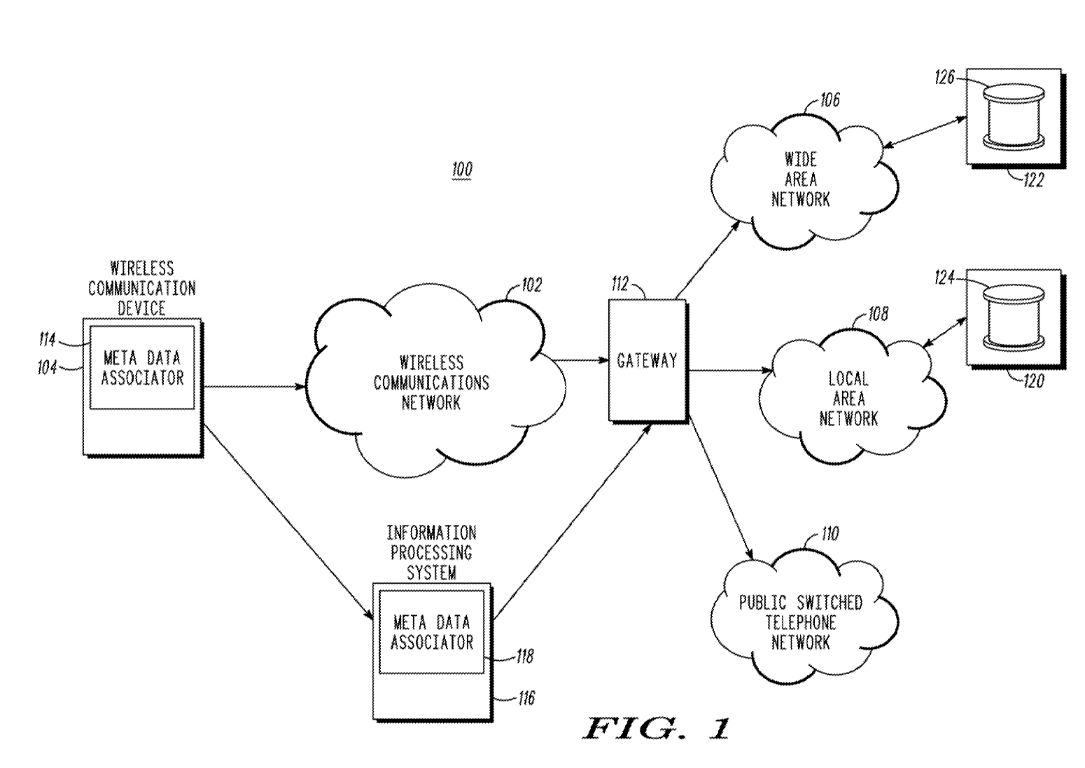

According to an embodiment of the present invention, as shown in FIG. 1, a wireless communications system 100 is illustrated. FIG. 1 shows a wireless communications network 102 that connects one or more wireless communication devices 104 to other wireless communication devices (not shown) and/or to other networks such as a wide area network 106, a local area network 108, a public switched telephone network 110, and the like via a gateway 112. The wireless communications network 102 comprises a mobile phone network, a mobile text messaging device network, a pager network, a wireless broadband data network, and/or the like. The wireless communication device 104 communicates with the wireless communications network 102 via a base station (not shown) and a base station controller (not shown).

Further, the communications standard of the wireless communications network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA), Orthogonal Frequency Division Multiplexing (OFDM), or the like. Additionally, the wireless communications network 102 also comprises text messaging standards, for example, Short Message Service (SMS), Enhanced Messaging Service (EMS), Multimedia Messaging Service (MMS), or the like. The wireless communications network 102 also allows for push-to-talk over cellular communications between capable wireless communication devices and wireless broadband communications.

The wireless network 102 supports any number of wireless communication devices 104. The support of the wireless network 102 includes support for mobile telephones, smart phones, text messaging devices, handheld computers, pagers, beepers, wireless communication cards, personal computers with wireless communication adapters, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities.

In one embodiment, the wireless communications network 102 is also capable of broadband wireless communications utilizing time division duplexing (“TDD”) as set forth, for example, by the IEEE 802.16e standard. The IEEE 802.16e standard is further described in IEEE Std. 802.16e 2005. The duplexing scheme TDD allows for the transmissions of signals in a downstream and upstream direction using a single frequency. It should be noted that other communication systems that the present invention may be applied to include UMTS LTE, 802.20 systems, and the like. Other such standards such as UMTS LTE (Long Term Evolution) and IEEE 802.20 are also applicable. Furthermore, the wireless communications system 100 is not limited to a system using only a TDD scheme. For example, TDD may be only used for a portion of the available communication channels in the system 100, while one or more schemes are used for the remaining communication channels.

In one embodiment, the wireless communication device 104 includes a metadata associator 114 for automatically associating metadata with digital images taken by the wireless communication device 104. Audio clips and/or video can also be associated with metadata information according to the embodiments of the present invention. For example, the wireless communication device, in one embodiment, comprises a digital imaging device such as a camera. The metadata associator 114, in one embodiment, associates the image captured by the camera with various metadata information such as time, date, location, events, and the like. The metadata associator 114 is discussed in greater detail below.

The wireless communication device 104, in one embodiment, can also be communicatively coupled to one or more information processing systems 116. The information processing system can be a personal computer, workstation, personal digital assistant, smartphone, set-top box, or the like. The wireless communication device 104, is communicatively coupled to the information processing system 116 via a wireless interface, a wired interface, an infrared interface, or the like. For example, the wireless communication device 104, in one embodiment, is communicatively coupled to the information processing system 116 via a Universal Serial Bus (“USB”) interface. Information and files such as the image files captured by the wireless device 104, calendar information, email, contact lists, word processing documents, and the like, can be transmitted between the wireless communication device 104 and the information processing system 116. In one embodiment, the wireless communication device 104 can be communicatively coupled to an information processing system 116 through the wireless communications network 102. For example, the wireless communication device 104 can communicate with another information processing system via a virtual private network connection.

In one embodiment, the information processing system 116 also includes a metadata associator 118, which is similar to the metadata associator included in the wireless communication device 104. As discussed above, the wireless communication device 104, can transfer image files over to the information processing system 116. Alternatively, image files stored on removable media such as secure digital memory card can also be read by the information processing system 116. The metadata associator 118, in one embodiment, automatically associates metadata information to each of the transferred or read image files. For example, information residing on the information processing system 116 can be used to attach metadata information to the image files. Also, information communicated from the wireless device 104 itself can also be used to attach metadata information to the image files. In another embodiment, the image files transferred from the wireless communication device 104, can be updated with additional metadata information by the metadata associator 118. For example, if the information processing system 116 comprises additional. related metadata, the metadata associator 118 can update the associated metadata with the additional related metadata.

The information processing system 116, in one embodiment, also searches additional databases 124, 126 residing on one or more additional information processing systems 120, 122. For example, if the word “Yellowstone” is metadata associated with an image file for the location of the picture, the information processing system 116 can query databases (e.g. relational databases) 124, 122 to identify further metadata information associated with “Yellowstone” such as “mountains”, “national park”, “Wyoming”, and the like. This additional metadata information helps to quickly identify an image file during a search. For example, a user can have a large picture database on the wireless communication device 104 or the information processing system 116 comprising thousands of image files. A user may not remember that the picture was taken at Yellowstone National Park, but does remember that there were mountains.

Without the information processing system 116 searching for and identifying other characteristics of Yellowstone National Park such as mountains, the user may have to manually search through each picture in the picture database. In one embodiment, this-metadata information identified by the information processing system 116 is associated (e.g. stored) with the corresponding metadata information already attached to the image file. For example, “mountains” is associated with “Yellowstone”. It should be noted that the wireless communication device can also perform the above example of querying various databases 124, 126 to identify additional related metadata information for the image files. The information processing system 116 is discussed in greater detail below.

Wireless Communication Device

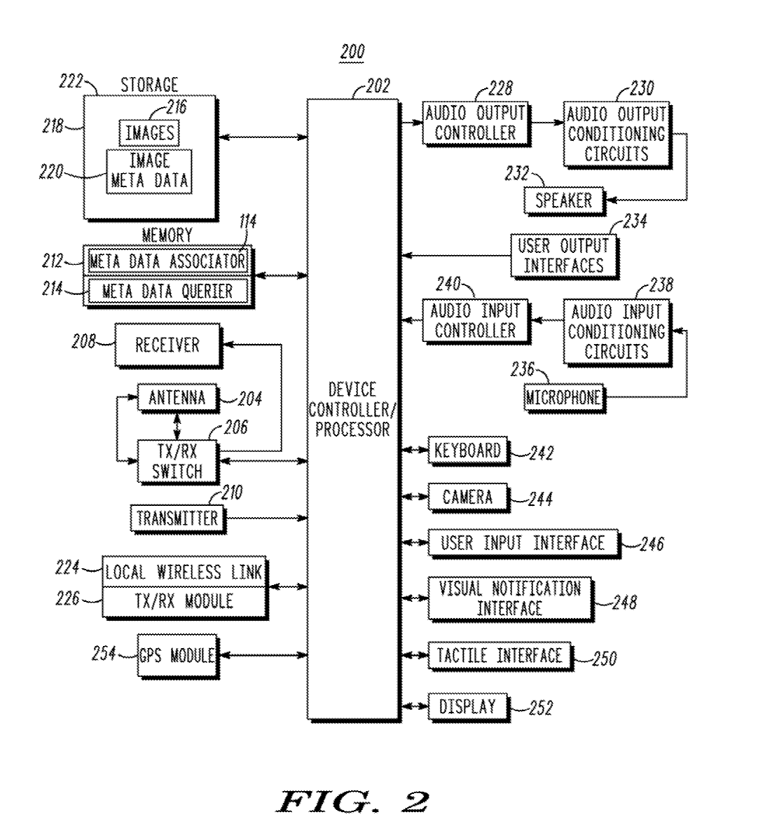

FIG. 2 is a block diagram illustrating a more detailed view of the wireless communication device 104. FIG. 2 illustrates only one example of a wireless communication device type. In one embodiment, the wireless communication device 104 is capable of transmitting and receiving wireless information on the same frequency such as in an 802.16e system using TDD. The wireless communication device 104 operates under the control of a device controller/processor 202, that controls the sending and receiving of wireless communication signals. In receive mode, the device controller 202 electrically couples an antenna 204 through a transmit/receive switch 206 to a receiver 208. The receiver 208 decodes the received signals and provides those decoded signals to the device controller 202.

In transmit mode, the device controller 202 electrically couples the antenna 204, through the transmit/receive switch 206, to a transmitter 210. The device controller 202 operates the transmitter and receiver according to instructions stored in the memory 212. These instructions include, for example, a neighbor cell measurement-scheduling algorithm. The memory 212 also includes the metadata associator 114 and a metadata querier 212. In one embodiment, the metadata associator 114 can include the metadata querier 212. The metadata associator 114, as discussed above, automatically associates images captured, for example, by a digital imaging device 244 (e.g., a camera) with various metadata. These images 216, in one embodiment, are stored in a non-volatile storage 218, which can be permanent or removable.

For example, a user takes a picture or captures video using the digital imaging device 244. The metadata associator 114, in one embodiment, without user intervention, then associates metadata with the picture. In another embodiment, the user can be prompted to start the metadata associating process. Alternatively, the user can manually start the metadata associating process. In addition to the metadata associator 114 associating metadata with the image file, a user can also manually enter metadata information. In one embodiment, the wireless communication device 104 does not include a metadata associator 114. In this embodiment, the image files 216 stored on the wireless communication device (or on a removable memory card) are associated with metadata information by the metadata associator 118 on the information processing system 116. For example, as discussed above, the wireless communication device 104 can be communicatively coupled to the information processing system 116.

In either example, the metadata information 220 associated with the image files 216 can be stored in the non-volatile storage 218 of the wireless communication device. Although shown in FIG. 2 as being separate from the image files 216, the metadata information 220 can also be directly embedded in its associated image file 216. In the example of FIG. 2, the metadata information 220 are separate files that point to their respective image file 216.

In one embodiment, metadata information 220 to be associated with the image files 216 is identified by the metadata querier 214. For example, metadata 220 can be extracted from a variety of places such as a calendar application, a global positioning satellite module 254, a clock, a tasking application, a weather application, and the like. When a user takes a picture or captures video with the digital imaging device 244, the metadata querier 214 queries the potential metadata provider for information to be associated with the image file 216.

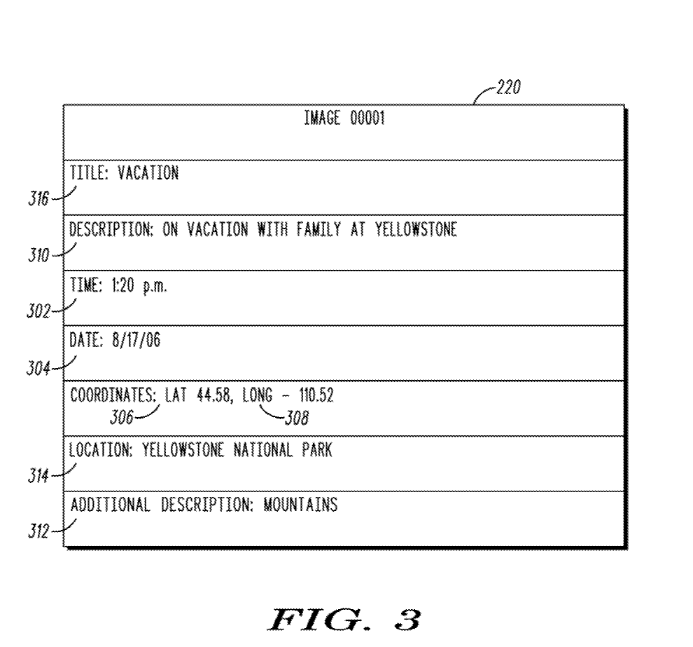

If a user is at a sporting event, the metadata querier 214 may take the date and time from the system clock of when the picture was taken; the GPS coordinates of the location where the picture was taken; weather conditions; information from the user's calendar that are related to the time and data of when the picture was taken; and any other predefined or user defined types of metadata. FIG. 3 shows an example of metadata 220 that has been retrieved by the metadata querier 214 and associated with an image file 216 by the metadata associator 114. In the example of FIG. 3, the user has taken a picture of mountains at Yellowstone National Park. The metadata querier 214 retrieves the time 302 and date 304 from the system clock. The metadata querier 214 also retrieves latitude 306 and longitude 308 coordinates from the GPS module 254. Event related information 310 from a calendar application is also retrieved.

For example, FIG. 3 shows event related information 310 of “on vacation with family at Yellowstone National Park”. Additional information such as “mountains” 312 that can be retrieved from an external database 124, 126 is also included. The coordinates 306, 308, in one embodiment can be crossed referenced by the metadata querier 214 to determine that the picture was taken at Yellowstone National Park. This information can be used to add “location” metadata information 314 to the image file 216. It should be noted that the metadata information 220 shown in FIG. 3 is only exemplary and does not limit the present invention. In another embodiment, the metadata information 220 can include information entered by a user such as a title 316 for the image 216.

By automatically associating the file images 216 with metadata information 220, a user does not have to tediously enter this information for each image file captured. A user can have thousands of image files 216 in a personal or on-line database that cane be easily searched. The automatic metadata association of the presenting invention also allows for more detailed metadata information to be added to the image files 216. This enables more accurate search results and recall of the circumstances under which the picture was taken.

The metadata querier 214, in one embodiment, can also query the information processing system 116 for metadata information 220 to be associated with the image files 216. For example, if the wireless communication device 104 does not include a calendar application, the metadata querier 214 can query a calendar application on the information processing system 116 for related events (or updates to the device's own calendar). Additionally, the metadata querier 214, in one embodiment, can retrieve additional metadata information 220 from external databases 124, 126. Using the example of FIG. 3, the metadata querier 214 uses the GPS coordinates 306, 308 to identify what location those coordinates are associated with. The metadata querier 214 identifies that the coordinates 306, 308 in FIG. 3 are for a location within Yellowstone National Park. The metadata querier 214 can then further retrieve information associated with Yellowstone National Park, such as mountains, famous land formations, and the like. This additional information can then be further associated with the image file 216 by the metadata associator 114.

Therefore, if the user wants to locate the “Yellowstone” picture, but cannot remember where the picture was taken, the user can enter mountains into a search and because the metadata information 220 of “mountains” has been associated with the “Yellowstone” picture, this is one of the pictures retuned by the search. In another embodiment, image analysis can be used to identify characteristics and/or elements of an image file 216. For example, a picture with a green field and white flowers can be analyzed to identify a green field and flowers. These characteristics can then be associated with the image file 216 as additional metadata information 220.

The storage 222, in addition to storing the image files 216 and the metadata information 220, can also store an application waiting to be executed (not shown). The wireless communication device 104, in this example, also includes an optional local wireless link 224 that allows the wireless communication device 104 to directly communicate with another wireless device without using a wireless network (not shown). The optional local wireless link 224, for example, is provided by Bluetooth, Infrared Data Access (IrDA) technologies, or the like. The optional local wireless link 224 also includes a local wireless link transmit/receive module 226 that allows the wireless device 104 to directly communicate with another wireless communication device such as wireless communication devices communicatively coupled to personal computers, workstations, and the like.

The wireless communication device 104 of FIG. 2 further includes an audio output controller 228 that receives decoded audio output signals from the receiver 208 or the local wireless link transmit/receive module 226. The audio controller 228 sends the received decoded audio signals to the audio output conditioning circuits 230 that perform various conditioning functions. For example, the audio output conditioning circuits 230 may reduce noise or amplify the signal. A speaker 232 receives the conditioned audio signals and allows audio output for listening by a user. The audio output controller 228, audio output conditioning circuits 230, and the speaker 232 also allow for an audible alert to be generated notifying the user of a missed call, received messages, or the like. The wireless communication device 104 further includes additional user output interfaces 234, for example, a head phone jack (not shown) or a hands-free speaker (not shown).

The wireless communication device 104 also includes a microphone 236 for allowing a user to input audio signals into the wireless communication device 104. Sound waves are received by the microphone 246 and are converted into an electrical audio signal. Audio input conditioning circuits 238 receive the audio signal and perform various conditioning functions on the audio signal, for example, noise reduction. An audio input controller 240 receives the conditioned audio signal and sends a representation of the audio signal to the device controller 202.

The wireless communication device 104 also comprises a keyboard 242 for allowing a user to enter information into the wireless communication device 104. The wireless communication device 104 further comprises a digital imaging device 244 such as a camera for allowing a user to capture still images or video images into memory 212. Furthermore, the wireless communication device 104 includes additional user input interfaces 246, for example, touch screen technology (not shown), a joystick (not shown), or a scroll wheel (not shown). In one embodiment, a peripheral interface (not shown) is also included for allowing the connection of a data cable to the wireless communication device 104. In one embodiment of the present invention, the connection of a data cable allows the wireless communication device 104 to be connected to a computer or a printer.

A visual notification (or indication) interface 248 is also included on the wireless communication device 104 for rendering a visual notification (or visual indication), for example, a sequence of colored lights on the display 252 or flashing one ore more LEDs (not shown), to the user of the wireless communication device 104. For example, a received multimedia message may include a sequence of colored lights to be displayed to the user as part of the message. Alternatively, the visual notification interface 248 can be used as an alert by displaying a sequence of colored lights or a single flashing light on the display 252 or LEDs (not shown) when the wireless communication device 104 receives a message, or the user missed a call.

The wireless communication device 104 also includes a tactile interface 250 for delivering a vibrating media component, tactile alert, or the like. For example, a multimedia message received by the wireless communication device 104, may include a video media component that provides a vibration during playback of the multimedia message. The tactile interface 250, in one embodiment, is used during a silent mode of the wireless communication device 104 to alert the user of an incoming call or message, missed call, or the like. The tactile interface 250 allows this vibration to occur, for example, through a vibrating motor or the like.

The wireless communication device 104 also includes a display 252 for displaying information to the user of the wireless communication device 104 and an optional Global Positioning System (“GPS”) module 254 The optional GPS module 348 determines the location and/or velocity information of the wireless communication device 104. This module 254 uses the GPS satellite system to determine the location and/or velocity of the wireless communication device 104. Alternative to the GPS module 254, the wireless communication device 104 may include alternative modules for determining the location and/or velocity of wireless communication device 104, for example, using cell tower triangulation and assisted GPS.

Information Processing System

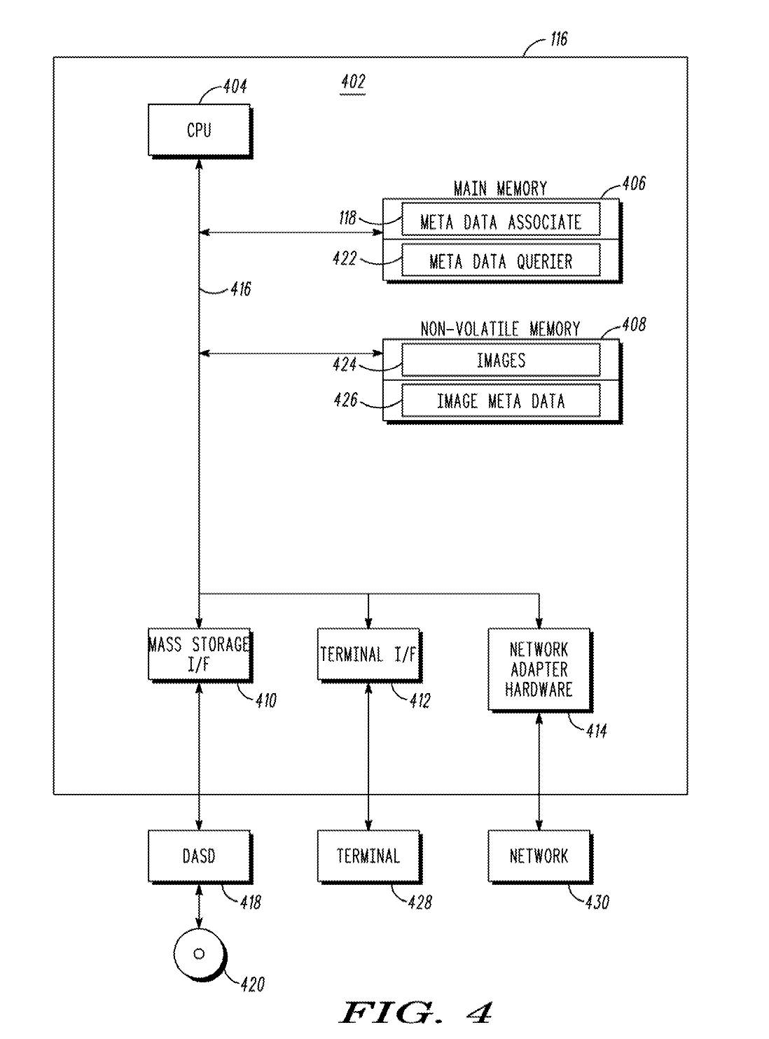

FIG. 4 is a block diagram illustrating a detailed view of an information processing system 116. The information processing system 116 is based upon a suitably configured processing system adapted to implement the exemplary embodiment of the present invention. Any suitably configured processing system is similarly able to be used as the information processing system 116 by embodiments of the present invention, for example, a personal computer, workstation, set-top box, wireless communication device, gaming counsel, or the like.

The information processing system 116 includes a computer 402. The computer 402 has a processor 404 that is connected to the main memory 406, non-volatile memory 408, mass storage interface 410, terminal interface 412, and a network adapter hardware 414 via a system bus 416. The mass storage interface 410 is used to connect mass storage devices such as data storage device 418 to the information processing system 116. One specific type of data storage device is a computer readable medium such as a CD drive, which may be used to store data to and read data from a CD 420 or its equivalent. Another type of data storage device is a data storage device configured to support, for example, NTFS type file system operations.

The main memory 406, in one embodiment, which can be volatile memory such as Random Access Memory (“RAM”) includes, among other things, the metadata associator 118 and a metadata querier 422. It should be noted that one or more of these components can reside within the non-volatile memory 408 instead of the main memory 406. The non-volatile memory 408, in one embodiment, includes image files 424 and metadata information 426 associated with a respective image file 424.

The metadata associator 118 and the metadata querier 422 of the information processing system 116 are similar to the metadata associator 114 and the metadata querier 214 of the wireless communication device 104 discussed above. Therefore, the discussion above with respect to these components is also applicable here. In one embodiment, the file images 424 can be transferred from the wireless communication device 104, a removable media card, taken with a digital imaging device (not shown) coupled to the information processing system 116, and the like. Metadata information 426 can already be associated with the image files 424 when the information processing system receives the files 424. In this example, the metadata associator 118 and a metadata querier 422 can update the metadata information 426 with additional metadata information. The metadata querier 422 can also query external databases 124, 126 as discussed above.

Although illustrated as concurrently resident in the main memory 406 and the non-volatile memory 408, it is clear that respective components of the main memory 406 and the non-volatile memory 408 are not required to be completely resident in the main memory 406 and the non-volatile memory 408 at all times or even at the same time. In one embodiment, the information processing system 116 utilizes conventional virtual addressing mechanisms to allow programs to behave as if they have access to a large, single storage entity, referred to herein as a computer system memory, instead of access to multiple, smaller storage entities such as the main memory 406, the non-volatile memory 408, and the data storage device 418. Note that the term “computer system memory” is used herein to generically refer to the entire virtual memory of the information processing system 116.

Although only one CPU 404 is illustrated for computer 402 computer systems with multiple CPUs can be used equally effectively. Embodiments of the present invention further incorporate interfaces that each includes separate, fully programmed microprocessors that are used to off-load processing from the CPU 404. Terminal interface 412 is used to directly connect one or more terminals 428 to computer 402 to provide a user interface to the computer 402. These terminals 428, which are able to be non-intelligent or fully programmable workstations, are used to allow system administrators and users to communicate with the information processing system 116. The terminal 428 is also able to consist of user interface and peripheral devices that are connected to computer 402 and controlled by terminal interface hardware included in the terminal I/F 412 that includes video adapters and interfaces for keyboards, pointing devices, and the like.

An operating system (not shown) included in the main memory 406 is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 400. The network adapter hardware 414 is used to provide an interface to a network 430 such as a wireless network, WAN 106 or LAN 108. The network adapter hardware 414, in one embodiment, also allows for the information processing system 116 and the wireless communication device 104 to be communicatively coupled together. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via a CD/DVD, e.g. CD 420, or other form of recordable media, or via any type of electronic transmission mechanism.

Process of Associating a Media File with Metadata Information

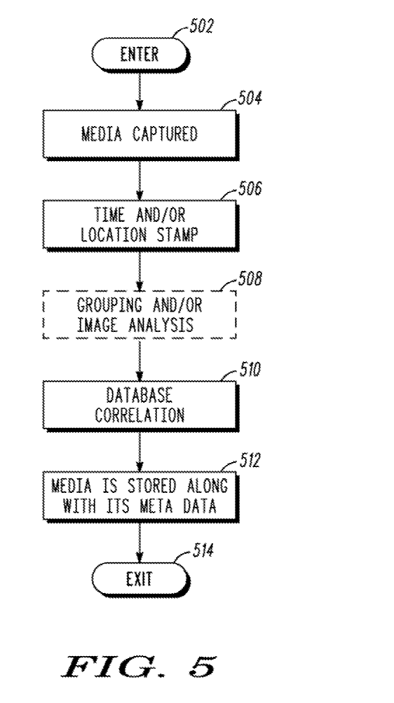

FIG. 5 illustrates a process associating metadata information with one or more media files 216 such as a picture, video clip, audio clip, and the like. The operational flow diagram of FIG. 5 begins at step 502 and flows directly to step 504. Media files 216, at step 504, are captured by a device such as a wireless communication device 104, a digital camera, a camcorder, and the like. The media files 216 can be still pictures, video, audio, and the like. The metadata associator 114, at step 506, automatically associates metadata information such as time, data, and location with the file 216. For example, the metadata querier 214 retrieves this information from a system clock, GPS module 254, and the like and passes it one to the metadata associator 114.

Optional image analysis and/or grouping, at step 508, can be optionally performed. Image processing can be used to determine the components and characteristics of the media file 216. Database correlation, at step 510, is then performed. For example, sources such as a calendar application, weather application, tasking application, email, and the like are queried by the metadata querier 214 to retrieve additional metadata information for the media file 216. This information can reside on the device itself, a communicatively coupled information processing system 116, or on other remote information processing systems 122, 124. This additional metadata information is associated with the media files 216, and the media files 216, at step 512, are then stored. The control flow then exits at step 514. The process discussed above can be performed by the device 104 capturing the media files 216 or an information processing system 116 receiving the files 216.

Another Process of Associating a Media File with Metadata Information

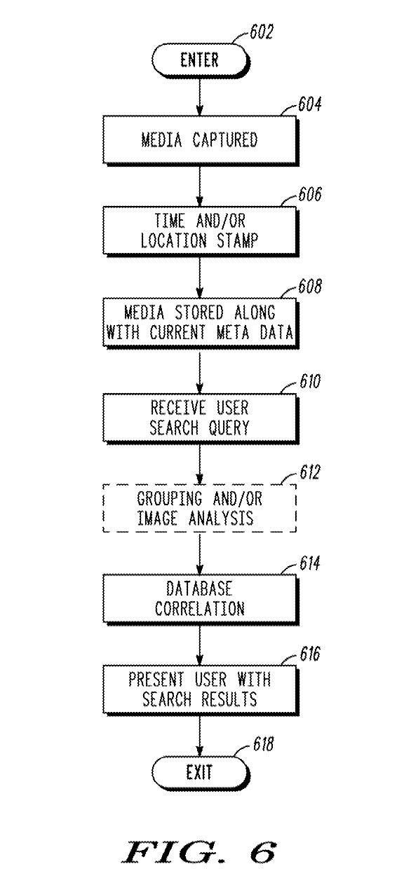

FIG. 6 illustrates another process of associating metadata information with one or more media files 216. In particular, FIG. 6 illustrates a process where additional metadata association is performed after a user submits a search query for a media file 216. The operational flow diagram of FIG. 6 begins at step 602 and flows directly to step 604. Media files 216, at step 604, are captured by a device such as a wireless communication device 104, a digital camera, a camcorder, and the like. The metadata associator 114, at step 606, automatically associates metadata information such as time, data, and location with the file 216. For example, the metadata querier 214 retrieves this information from a system clock, GPS module 254, and the like and passes it one to the metadata associator 114. The media files 216 and their associated metadata, at step 608, are then stored.

A user search query, at step 610, is received. For example, a user can enter one or more keywords to search for a particular media file 216 or group of media files 216. The keywords can be used to find additional words related to the keywords. For example, a user may have pictures of mountains in Yellowstone National Park. The user may want to search for these pictures but only remembers that they were taken at Yellowstone National Park. Currently, the metadata information associated with these pictures in only “mountains”. If the user simply enters “Yellowstone” as a search keyword, these pictures are not returned by the search results. However, in one embodiment, group and/or image analysis, at step 612 is performed to identify characteristics and components of the files to be used as additional metadata information. Database correlation, at step 614, is can also be performed to retrieve additional metadata information.

For example, sources such as a calendar application, weather application, tasking application, email, and the like are queried by the metadata querier 214 to retrieve additional metadata information for the media file 216. Knowledge databases can also be queried to retrieve metadata information. For example, using the keyword “Yellowstone”, a queried knowledgebase results in “mountains” being associated with Yellowstone National Park. The search uses this additional metadata to identify pictures with “mountains” and the desired media files 216, at step 616, are presented to the user. The control flow then exits at step 618. The process discussed above can be performed by the device 104 capturing the media files 216 or an information processing system 116 receiving the files 216.

Non-Limiting Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Embodiments of the invention can be implemented as a program product for use with a computer system such as, for example, the computing environment shown in FIG. 1 and described herein. The program(s) of the program product defines functions of the embodiments (including the methods described herein) and can be contained on a variety of computer readable media. Illustrative computer readable medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such computer readable media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for associating metadata with a media file, the method comprising:
storing at least one media file associated with identification information;
retrieving a data set from at least one data source, wherein the data set is retrieved at least in part based on the identification information;
automatically, and without user intervention, generating metadata from the data set based at least in part on the identification information; and
associating the metadata with the at least one media file.

2. The method of claim 1, wherein the at least one media file comprises at least one of:
an image file;
a video file;
an audio file; and
a multi-media file.

3. The method of claim 1, further comprising at least one of:
capturing the at least one media file with a media capturing device; and
receiving the at least one media file from an external device that is external to the electronic device.

4. The method of claim 1, wherein the retrieving further comprises at least one of:
querying a personal information manager for information that can be associated with the at least one media file; and
querying a location tracking module for determining a location where at least a portion of the at least one media file was created.

5. The method of claim 1, further comprising:
querying at least one remotely located database for information related to metadata that can be associated with the at least one media file.

6. The method of claim 1, wherein the retrieving further comprises:
querying a remotely located personal information manager for information related to metadata that can be associated with the at least one media file.

7. The method of claim 1, further comprising:
performing image analysis on the at least one media file; and
associating metadata with the at least one media file based at least in part on the result of the image analysis.

8. The method of claim 1, further comprising:
receiving at least one search keyword from a user, wherein the at least one search keyword being associated by the user to the at least one media file.

9. The method of claim 8, further comprising:
retrieving from at least one database, based on the received at least one search keyword and metadata associated with the at least one media file, additional information related to the metadata associated with the at least one media file; and
identifying, based on the retrieval of the additional information, a set of media files for presenting to the user.

10. An information processing system for associating metadata with a media file, the information processing system comprising:
a memory comprising at least identification information for at least one media file;
a processor communicatively coupled with the memory;
a metadata querier communicatively coupled with the memory and the processor, wherein the metadata querier retrieves a data set from at least one data source, wherein the data set is retrieved at least in part based on the identification information; and
a metadata associator communicatively coupled to the metadata querier, wherein the metadata associator automatically, and without user intervention, generates metadata from the data set based at least in part on the identification information.

11. The information processing system of claim 10, wherein the media file is stored in at least one of the memory and a memory residing on an electronic device communicatively coupled to the information processing system;

12. The information processing system of claim 11, wherein the metadata associator associates the generated metadata with the media file.

13. The information processing system of claim 11, further comprising:
a transmitter for transmitting the generated metadata to the electronic device communicatively coupled to the information processing system.

14. The information processing system of claim 10, wherein the information processing system comprises a set top box device.

15. A portable electronic device comprising:
a memory comprising at least one media file associated with identification information;
a processor communicatively coupled with the memory;
a metadata querier communicatively coupled with the memory and the processor, wherein the metadata querier retrieves a data set from at least one data source, wherein the data set is retrieved at least in part based on the identification information; and
a metadata associator communicatively coupled to the metadata querier, wherein the metadata associator automatically, and without user intervention, generates metadata from the data set based at least in part on the identification information, and wherein the metadata associator associates the metadata with the at least one media file.

16. The portable electronic device of claim 15, wherein the portable electronic device comprises a wireless device, and wherein the data set is retrieved, at least in part, by wirelessly retrieving data from a remotely located data source.

17. The portable electronic device of claim 16, wherein the wireless device comprises a cellular phone, and wherein the data set is retrieved, at least in part, by cellular communication that wirelessly retrieves data from a remotely located data source.

18. The portable electronic device of claim 15, further comprising:
a media capturing device, communicatively coupled with the processor, for capturing the at least one media file.

19. The portable electronic device of claim 15, wherein the at least one data source resides on the portable electronic device.
